(19) United States
(12) Patent Application Publication
(10) Pub. No.: US 2019/0322219 A1
(43) Pub. Date: Oct. 24, 2019

(54) ANTI-GLARE REARVIEW MIRROR AND USE METHOD THEREOF

(71) Applicant: BOE TECHNOLOGY GROUP CO., LTD., Beijing (CN)

(72) Inventor: Lin ZHU, Beijing (CN)

(21) Appl. No.: 16/379,486

(22) Filed: Apr. 9, 2019

(30) Foreign Application Priority Data
Apr. 18, 2018 (CN) 201810351155.8

(51) Int. Cl. B60R 1/08; G02F 1/15

(52) U.S. Cl. CPC B60R 1/088; G02F 1/15

(57) ABSTRACT

The present disclosure provides an anti-glare rearview mirror and a use method thereof. The anti-glare rearview mirror includes: a lens, the lens includes an outer lens and an inner lens, the inner lens is located at a rear side of the outer lens; a first photosensor, the first photosensor is disposed on the lens and is located at a rear side of the outer lens, and the first photosensor is configured to receive light irradiated from a front side of the anti-glare rearview mirror and generate a corresponding current; and an electrochromic component, the electrochromic component is located between the outer lens and the inner lens, and the electrochromic component is configured to be applied with a corresponding voltage according to the current generated by the first photosensor, and then change a light transmission ratio of the electrochromic component.

### CROSS-REFERENCE TO RELATED APPLICATION

This application claims priority to Chinese Patent Application No. 201810351155.8, submitted to Chinese Patent Office on Apr. 18, 2018, titled “AN ANTI-GLARE REARVIEW MIRROR AND CONTROL METHOD THEREOF”, which is incorporated herein by reference in its entirety.

### TECHNICAL FIELD

The present disclosure relates to the field of anti-glare rearview mirror technologies, in particular, to an anti-glare rearview mirror and use method thereof.

### BACKGROUND

A rearview mirror plays an important role as an auxiliary facility for vehicle safety. It can reflect situations behind the car and expand the driver's field of vision. However, if a car in the front encounter the headlights of a car in the back while driving at night, strong reflections may occur, and light will enter eyes of the driver. A short night blindness will occur if the human eyes are exposed to strong light, which will affect safe driving. Therefore, at present, anti-glare technology is generally used in the manufacture of rearview mirrors of vehicles to reduce the reflection intensity of the irradiated light from a car in the back, and to reduce the stimulation to the driver by the strong light.

### SUMMARY

Some embodiments of the present disclosure provide an anti-glare rearview mirror, including: a lens, the lens includes an outer lens and an inner lens, the inner lens is located at a rear side of the outer lens; a first photosensor, the first photosensor is disposed on the lens and is located at a rear side of the outer lens, and the first photosensor is configured to receive light irradiated from a front side of the anti-glare rearview mirror and generate a corresponding current; and an electrochromic component, the electrochromic component is located between the outer lens and the inner lens, and the electrochromic component is configured to be applied with a corresponding voltage according to the current generated by the first photosensor, and then change a light transmission ratio of the electrochromic component.

In some embodiments of the present disclosure, the lens includes a color changing space, the color changing space is a space formed by an orthographic projection of the electrochromic component projected on the lens along a thickness direction of the lens, and the first photosensor is disposed at a rear side of the outer lens and is located outside the color changing space.

In some embodiments of the present disclosure, the outer lens includes a first region, the first region is a region formed by an orthographic projection of the electrochromic component projected on the outer lens along a thickness direction of the outer lens, and the first photosensor is disposed on a rear side surface of the outer lens and is located outside the first region.

In some embodiments of the present disclosure, the inner lens is a transflective lens.

In some embodiments of the present disclosure, the anti-glare rearview mirror further includes a controller, the controller is configured to apply a first voltage to the electrochromic component when a value of the current generated by the first photosensor is in a first current value interval;

Wherein, the first current value interval is one of a plurality of subintervals into which the current value interval of the first photosensor is divided; the first voltage is a voltage capable of making the light from which the first current value interval is generated reach a predetermined light intensity range after the light passing through the electrochromic component; the predetermined light intensity range is an anti-glare light intensity range.

In some embodiments of the present disclosure, the first voltage is a voltage which is applied to the electrochromic component corresponds to a small end point of the first current value interval.

In some embodiments of the present disclosure, the lens includes a color changing space, the color changing space is a space formed by an orthographic projection of the electrochromic component projected on the lens along a thickness direction of the lens, and the first photosensor is disposed at a rear side of the outer lens and is located inside the color changing space.

In some embodiments of the present disclosure, the inner lens is a transflective lens, the inner lens includes a second region, the second region is a region formed by an orthographic projection of the electrochromic component projected on the inner lens along a thickness direction of the inner lens, and the first photosensor is disposed on a rear side surface of the inner lens and is located inside the second region.

In some embodiments of the present disclosure, the anti-glare rearview mirror further includes a controller, the controller is configured to apply a second voltage to the electrochromic component when a value of the current generated by the first photosensor is in a second current value interval;

after the electrochromic component is applied with the second voltage, the controller is further configured to perform at least one time of adjustment process: if a value of the present current generated by the first photosensor is not equal to a current threshold value, the present voltage applied to the electrochromic component is adjusted;

wherein, the second current value interval is one of a plurality of subintervals into which the current value interval of the first photosensor is divided; the second voltage is a voltage, when the voltage applied to the electrochromic component is zero, capable of making the light from which the second current value interval is generated reach a predetermined light intensity range after the light passing through the electrochromic component; the current threshold value is, in a case where the electrochromic component is applied with a certain voltage, a value of the current generated by the first photosensor when the light passing through the electrochromic component reaches a predetermined light intensity range; the predetermined light intensity range is an anti-glare light intensity range.

In some embodiments of the present disclosure, the second voltage is a voltage which is applied to the electrochromic component corresponds to a small end point of the second current value interval.

In some embodiments of the present disclosure, “if a value of the present current generated by the first photosensor is not equal to a current threshold value, the present voltage applied to the electrochromic component is adjusted” includes: if the value of the present current generated by the first photosensor is greater than the current threshold value, the present voltage applied to the electrochromic component is increased; or, if the value of the present current generated by the first photosensor is less than the current threshold value, the present voltage applied to the electrochromic component is decreased.

In some embodiments of the present disclosure, the anti-glare rearview mirror further includes a second photosensor, the second photosensor is configured to sense a light intensity at a rear side of the anti-glare rearview mirror.

In some embodiments of the present disclosure, the anti-glare rearview mirror further includes a controller, the controller is configured to, when a value of the current generated by the first photosensor is greater than a value of a current generated by the second photosensor, a voltage applied to the electrochromic component is adjusted according to the value of the current generated by the first photosensor.

In some embodiments of the present disclosure, the anti-glare rearview mirror further includes a display device, the display device is located at a rear side of the lens.

Some embodiments of the present disclosure provide a use method of the anti-glare rearview mirror, including following steps: the first photosensor disposed at a rear side of the outer lens receiving the light irradiated from a front side of the anti-glare rearview mirror and generating a corresponding current; a voltage applied to the electrochromic component being adjusted according to a value of the current generated by the first photosensor, so that a light transmission ratio of the electrochromic component is changed.

In some embodiments of the present disclosure, the lens includes a color changing space, the color changing space is a space formed by an orthographic projection of the electrochromic component projected on the lens along a thickness direction of the lens, and the first photosensor is located outside the color changing space; by this time, “a voltage applied to the electrochromic component being adjusted according to a value of the current generated by the first photosensor” includes:

a first voltage is applied to the electrochromic component when a value of the current generated by the first photosensor is in a first current value interval;

wherein, the first current value interval is one of a plurality of subintervals into which the current value interval of the first photosensor is divided; the first voltage is a voltage capable of making the light from which the first current value interval is generated reach a predetermined light intensity range after the light passing through the electrochromic component; the predetermined light intensity range is an anti-glare light intensity range.

In some embodiments of the present disclosure, the lens includes a color changing space, the color changing space is a space formed by an orthographic projection of the electrochromic component projected on the lens along a thickness direction of the lens, and the first photosensor is located inside the color changing space; by this time, “a voltage applied to the electrochromic component being adjusted according to a value of the current generated by the first photosensor” includes:

a second voltage is applied to the electrochromic component when a value of the current generated by the first photosensor is in a second current value interval;

after the electrochromic component is applied with the second voltage, if a value of the present current generated by the first photosensor is not equal to a current threshold value, a present voltage applied to the electrochromic component is adjusted;

wherein, the second current value interval is one of a plurality of subintervals into which the current value interval of the first photosensor is divided; the second voltage is a voltage, when the voltage applied to the electrochromic component is zero, capable of making the light from which the second current value interval is generated reach a predetermined light intensity range after the light passing through the electrochromic component; the current threshold value is, in a case where the electrochromic component is applied with a certain voltage, a value of the current generated by the first photosensor when the light passing through the electrochromic component reaches a predetermined light intensity range.

In some embodiments of the present disclosure, “if a value of the present current generated by the first photosensor is not equal to a current threshold value, a present voltage applied to the electrochromic component is adjusted” includes:

if the value of the present current generated by the first photosensor is greater than the current threshold value, the present voltage applied to the electrochromic component is increased; or, if the value of the present current generated by the first photosensor is less than the current threshold value, the present voltage applied to the electrochromic component is decreased.

In some embodiments of the present disclosure, in a case where the anti-glare rearview mirror further includes a second photosensor, when a value of the current generated by the first photosensor is greater than a value of a current generated by the second photosensor, a voltage applied to the electrochromic component is adjusted according to the value of the current generated by the first photosensor.

### BRIEF DESCRIPTION OF THE DRAWINGS

In order to describe technical solutions in embodiments of the present disclosure more clearly, the accompanying drawings to be used in the description of disclosure will be introduced briefly. Obviously, the accompanying drawings to be described below are merely some embodiments of the present disclosure, and a person of ordinary skill in the art can obtain other drawings according to these drawings without paying any creative effort.

FIG. 1 is a structural schematic diagram showing an anti-glare rearview mirror in related art;

FIG. 2 is a structural schematic diagram showing an anti-glare rearview mirror according to some embodiments of the present disclosure (a photosensor is disposed at an inner side of an outer lens);

FIG. 3 is a structural schematic diagram showing an anti-glare rearview mirror according to some embodiments of the present disclosure (a photosensor is disposed at an inner side of an inner lens);

FIG. 4 is a flow chart showing a use method of an anti-glare rearview mirror according to some embodiments of the present disclosure (a photosensor is disposed at an inner side of an outer lens);

FIG. 5 is a flow chart showing a use method of an anti-glare rearview mirror according to some embodiments of the present disclosure (a photosensor is disposed at an inner side of an inner lens).

### DETAILED DESCRIPTION

The technical solutions in some embodiments of the present disclosure will be described clearly and completely with reference to the accompanying drawings in some embodiments of the present disclosure. Obviously, the described embodiments are merely some but not all of embodiments of the present disclosure. All other embodiments made on the basis of the embodiments of the present disclosure by a person of ordinary skill in the art without paying any creative effort shall be included in the protection scope of the present disclosure.

It should be understood that in the description of the present disclosure, orientations or positional relationships indicated by terms “center”, “upper”, “lower”, “front”, “rear”, “left”, “right”, “vertical”, “horizontal”, “top”, “bottom”, “inner”, “outer”, etc. are based on orientations or positional relationships shown in the drawings, merely to facilitate and simplify the description of the present disclosure, but not to indicate or imply that the referred devices or elements must have a particular orientation, or must be constructed or operated in a particular orientation. Therefore they should not be construed as limitations to the present disclosure.

In the description of the present disclosure, it should be noted that the terms “mounted”, “communicated”, and “connected” should be understood in a broad sense unless specifically defined or limited. For example, it may be a permanent connection, a detachable connection, or it may be an integrated connection; the persons skilled in the art can understand the specific implications of the above-mentioned terms in the present disclosure according to the specific circumstances.

The terms “first” and “second” are used for descriptive purposes only and are not to be construed as indicating or implying the relative importance or implicitly indicating the number of indicated technical features. Thus, features defined as “first”, “second” may explicitly or implicitly include one or more of the features. In the description of the present disclosure, “plurality” means two or more unless otherwise specified.

In related art, a common anti-glare rearview mirror is added with a layer of electrochromic material inside a lens of the rearview mirror, a controller controls to deepen the color of this material in order to to change a light transmission ratio thereof when strong light irradiates into the rearview mirror, and an anti-glare effect is achieved.

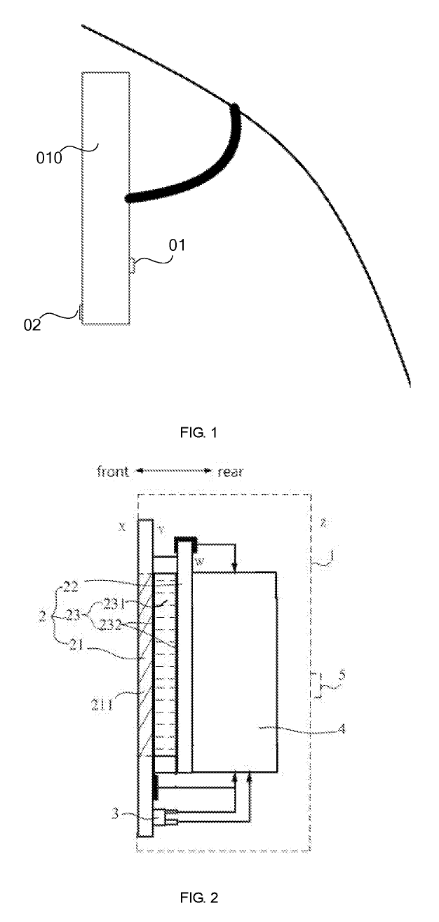

As shown in FIG. 1, a rearview mirror 010 installed on a front side of a vehicle has a first photosensor 01 and a second photosensor 02, the first photosensor 01 is located on a rear side shell (the head direction) of the rearview mirror 010 to sense a light intensity of a rear side environment of the rearview mirror, and the second photosensor 02 is located on a front side shell (the tail direction) of the rearview mirror 010 to sense a light intensity of a front side environment of the rearview mirror.

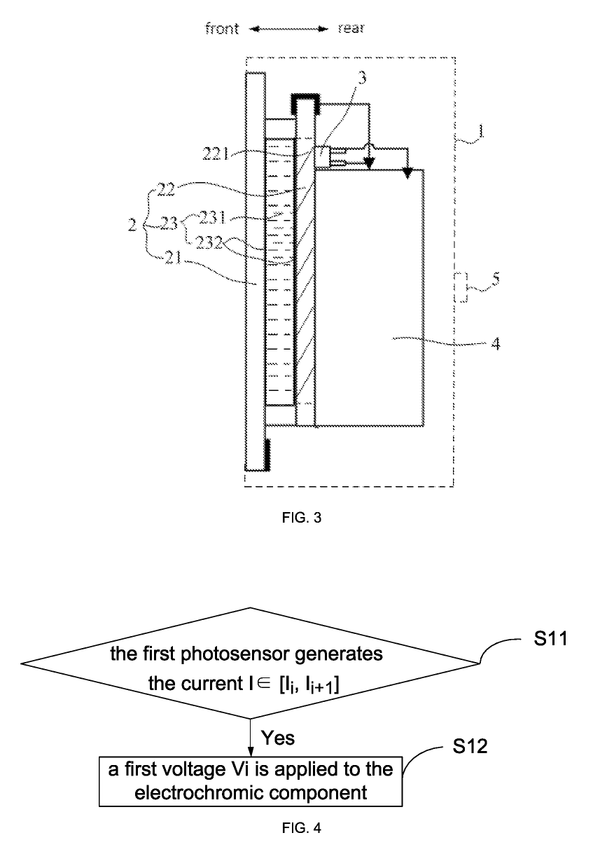

As shown in FIG. 2 and FIG. 3, some embodiments of the present disclosure provide an anti-glare rearview mirror, the anti-glare rearview mirror includes: a lens 2, the lens 2 includes an outer lens 21 and an inner lens 22, the inner lens 22 is located at a rear side of the outer lens 21; a first photosensor 3, the first photosensor 3 is disposed on the lens 2 and is located at a rear side of the outer lens 21, and the first photosensor 3 is configured to receive light irradiated from a front side of the anti-glare rearview mirror and generate a corresponding current; and an electrochromic component 23, the electrochromic component 23 is located between the outer lens 21 and the inner lens 22, and the electrochromic component 23 is configured to be applied with a corresponding voltage according to the current generated by the first photosensor 3, and then change a light transmission ratio of the electrochromic component 23.

The electrochromic component 23 includes an electrochromic material layer 231 and an electrode 232 to drive the electrochromic material layer 231 to change color, as shown in FIG. 2. The electrode 232 includes a first electrode and a second electrode, the first electrode and the second electrode are respectively located at front and rear sides of the electrochromic material layer 231.

In some embodiments of the present disclosure, the lens 2 includes a color changing space, the color changing space is a space formed by an orthographic projection of the electrochromic component 23 projected on the lens 2 along a thickness direction of the lens 2, and the first photosensor 3 is disposed on the lens 2 and at a rear side of the outer lens 21, and is located outside the color changing space.

In some embodiments of the present disclosure, the lens 2 includes a color changing space, the color changing space is a space formed by an orthographic projection of the electrochromic component 23 projected on the lens 2 along a thickness direction of the lens 2, and the first photosensor 3 is disposed on the lens 2 and at a rear side of the outer lens 21, and is located inside the color changing space.

In the anti-glare rearview mirror provided by some embodiments of the present disclosure: that the first photosensor 3 is disposed on the lens 2 means that the first photosensor 3 is carried by the lens 2; the orientation word of “front” means a direction along a thickness direction of the lens 2 and points to a side for observation of the anti-glare rearview mirror; the orientation word of “rear” means a direction along a thickness direction of the lens 2 and away from a side for observation of the anti-glare rearview mirror; the front side of the anti-glare rearview mirror refers to the side for observation of the anti-glare rearview mirror, as the X side shown in FIG. 2; the rear side of the anti-glare rearview mirror refers to the side of the anti-glare rearview mirror opposite to the front side, as the Z side shown in FIG. 2.

The rear side of the outer lens 21 refers to the side where the inner lens 22 is located, as the Y side shown in FIG. 2; the rear side of the inner lens 22 refers to the side of the inner lens 22 away from the outer lens 21, as the W side shown in FIG. 2.

In the anti-glare rearview mirror provided by some embodiments of the present disclosure, since the first photosensor 3 is disposed on the lens 2 and is located on the rear side of the outer lens 21, i.e., the first photosensor 3 is hided inside the lens 2 of the rearview mirror, there is no need for a space to be left for the first photosensor 3 on the front side shell 1 of the rearview mirror, and an area of the frame around the lens 2 of the rearview mirror may be greatly reduced, thereby the area ratio of the lens 2 is increased and the users usage experience is improved.

In some embodiments of the present disclosure, a location where the first photosensor 3 is disposed on the lens 2 is not unique, and at least includes following two implementations:

FIG. 2 shows one implementation for the first photosensor 3 being disposed on the lens 2, the outer lens 21 includes a first region 211 (region with diagonal lines in FIG. 2), the first region 211 is a region formed by an orthographic projection of the electrochromic component 23 projected on the outer lens 21 along a thickness direction of the lens 2, and the first photosensor 3 is disposed on a rear side surface of the outer lens 21 and is located outside the first region 211. In this implementation, the first photosensor 3 is disposed on the rear side surface of the outer lens 21, and does not need to occupy a space of the shell 1 around the lens 2, thereby an area of the frame around the lens 2 of the rearview mirror may be reduced, and the area ratio of the lens 2 is increased.

In the implementation where the first photosensor 3 is disposed on the rear side surface of the outer lens 21 and is located outside the first region 211 (the implementation shown in FIG. 2), the type of the inner lens 22 is not unique, for example, the inner lens 22 may be a reflective lens. And in some embodiments, the inner lens 22 may be a transflective lens.

When the inner lens 22 is a transflective lens, a display device 4 may be disposed on the rear side of the inner lens 22, the light generated by a display screen of the display device 4 may penetrate the inner lens 22 and irradiate to the front side of the anti-glare rearview mirror to be seen by a person at the front side thereof, then functions of the rearview mirror may be greatly expanded and the users usage experience is increased.

FIG. 3 is another implementation for the first photosensor 3 being disposed on the lens 2, the inner lens 22 is a transflective lens, the inner lens 22 includes a second region 221 (region with diagonal lines in FIG. 3), the second region 221 is a region formed by an orthographic projection of the electrochromic component 23 projected on the inner lens 22 along a thickness direction of the inner lens 22, and the first photosensor 3 is disposed on a rear side surface of the inner lens 22 and is located inside the second region 221. In this implementation, the inner lens 22 is a transflective lens, thus a part of light irradiated to the inner lens 22 may be reflected and another part of the light may penetrate the inner lens 22 and irradiate to the first photosensor 3, the first photosensor 3 may sense an intensity of the light irradiated on it and generate a corresponding current, the electrochromic component may thus be applied with a corresponding voltage according to the current generated by the first photosensor 3, so that a light transmission ratio of the electrochromic component 23 is changed.

In this implementation the first photosensor 3 is disposed on the rear side surface of the inner lens 22, which likewise does not need to occupy a space of the shell 1 around the lens 2, thereby an area of the frame around the lens 2 of the rearview mirror may be reduced, and the area ratio of the lens 2 is increased; in addition, since the first photosensor 3 is disposed on the rear side surface of the inner lens 22 and is located inside the second region 221, the first photosensor 3 is located inside a reflective region (i.e., the region occupied by the inner lens 22) of the lens 2, and does not occupy the region outside the reflective region of the lens 2, in this way the region outside the reflective region of the lens 2 may be designed small, thereby the proportion of the reflective region of the lens 2 is increased, and the lens 2 may have a better display effect in an anti-glare condition.

In the anti-glare rearview mirror provided by some embodiments of the present disclosure, that the electrochromic component 23 is applied with a voltage refers to the electrode 232 of the electrochromic component 23 is applied with a voltage.

In the anti-glare rearview mirror provided by some embodiments of the present disclosure, as shown in FIG. 2 and FIG. 3, a display device 4 may further be disposed at the rear side of the lens 2, when an anti-glare function of the rearview mirror is not activated, the display device 4 may be configured to display video information, for example, to display a navigation map, etc. Thus the rearview mirror not only has an anti-glare function, but also has a display function, which greatly expands functions of the rearview mirror. The display device 4 includes a display screen and a display module system circuit, the display screen and the first photosensor 3 may both connect to the display module system circuit.

The anti-glare rearview mirror provided by some embodiments of the present disclosure further includes a controller, the controller is configured to adjust the voltage applied to the electrochromic component 23 according to a value of the current (may be called a light current) generated by the first photosensor 3, thus a light transmission ratio of the electrochromic component 23 is changed, strong light is avoided to reflected into the driver's eyes, and driving safety is improved.

The controller may include a microcontroller unit (MCU for short).

When a structure of the rearview mirror is different, the control mode of the controller is different accordingly. For example, when the first photosensor 3 is disposed at a rear side of the outer lens 21 and is located outside the color changing space, as shown in FIG. 4, the controller is used to apply a first voltage to the electrochromic component 23 when a value of the current generated by the first photosensor 3 is in a first current value interval; wherein, the first current value interval is one of a plurality of subintervals into which the current value interval of the first photosensor 3 is divided. For example, the current value interval of the first photosensor 3 may be equally divided into a plurality of subintervals, the first current value interval [Iᵢ, Iᵢ₊₁] is the i-th subinterval of the plurality of equally divided subintervals; the current value interval of the first photosensor 3 is the range of a value of the current generated by the first photosensor 3; the first voltage is a voltage capable of making the light from which the first current value interval is generated reach a predetermined light intensity range (that is, an anti-glare light intensity range, the predetermined light intensity may be a value or a value interval) after passing through the electrochromic component 23. According to the interval in which the value of the current generated by the first photosensor 3 is located, the controller may apply a voltage corresponding to the interval to the electrochromic component 23, therefore, the adjustment of the light transmission ratio of the electrochromic component 23 can be completed under the condition that the light intensity is constantly changing, so that the intensity of the light reflected into the drivers eyes is not too high, and a glare generated by too strong light is avoided.

The type of the first current value interval is not unique, for example, it may be a closed interval [Iᵢ, Iᵢ₊₁], as shown in FIG. 4; in addition, the first current value interval may also be a left open right closed interval, a left closed right open interval, and is not limited herein.

The first voltage may be a voltage which is applied to the electrochromic component 23 corresponds to a small end point (i.e., a left end point) of the first current value interval. For example, as shown in FIG. 4, when a current I generated by the first photosensor 3 is located in a first current value interval [Iᵢ, Iᵢ₊₁], the first voltage applied to the electrochromic component 23 is the voltage Vᵢ corresponding to the small end point Iᵢ of the first current value interval. Or, the first voltage may also be a voltage applied to the electrochromic component 23 corresponding to a big end point (i.e., a right end point) of the first current value interval, for example, when a current I generated by the first photosensor 3 is located in a first current value interval [Iᵢ, Iᵢ₊₁], the first voltage applied to the electrochromic component 23 is the voltage Vᵢ₊₁ corresponding to the big end point of the first current value interval. In addition, the first voltage may also be a voltage applied to the electrochromic component 23 corresponding to any value of the first current value interval; the above first voltage can be determined according to an actual situation, and is not limited herein.

TABLE 1
Correspondence between a value at an end point of the first current
value interval and a voltage applied to the electrochromic component

| | voltage which is applied to the |
|---|---|
| | electrochromic component corresponding |
| value at an end point of the | to the value at an end point of |
| first current value interval | the first current value interval |
| I₁ | V₁ |
| I₂ | V₂ |
| . . . | . . . |
| Iᵢ | Vᵢ |
| . . . | . . . |
| Iₘ | Vₘ |

The m is the maximum value of i in table 1.

It should be noted that: in the anti-glare rearview mirror provided by some embodiments of the present disclosure, when light from front side of the anti-glare rearview mirror irradiates to the lens 2, the first photosensor 3 will generate current with different values under different light intensities. The higher the intensity of light from front side of the anti-glare rearview mirror, the bigger the value of the current generated by the first photosensor 3, the bigger the voltage applied to the electrochromic component 23 by the controller, and the lower the light transmission ratio of the electrochromic component 23, thus, for any current with different values generated by the first photosensor 3, there is a corresponding light transmission ratio of the electrochromic component 23, simultaneously, there is a corresponding voltage applied to the electrochromic component 23. Through a test method, the voltage which is applied to the electrochromic component 23 corresponding to values at end point Iᵢ, Iᵢ₊₁ of the first current value interval [Iᵢ, Iᵢ₊₁] may be obtained, as shown in table 1. Then, the controller may apply a corresponding voltage to the electrochromic component 23 according to the value at the end point of the first current value interval where a current I generated by the first photosensor 3 is located and the correspondence shown in table 1.

For example, the voltage which is applied to the electrochromic component 23 corresponding to the values at end point of the first current value interval may be measured by the following method: taking the anti-glare rearview mirror with the first photosensor 3 disposed on the rear side surface of the outer lens 21 and located outside the first region 211 as a test object, the lens 2 is irradiated with light of a certain intensity so that a current Iᵢ is generated by the first photosensor 3, and then the light intensity stays the same, and the value of the voltage applied to the electrochromic element 23 is adjusted in order from small to large, when the light reflected by the lens 2 reaches a predetermined light intensity range, a value of the voltage Vᵢ applied to the electrochromic component 23 is the voltage corresponding to Iᵢ, therefore, the first voltage is, in a case where the value of the current generated by the first photosensor 3 from light is Iᵢ, a voltage applied to the electrochromic component 23 when the light reaches a predetermined light intensity range after being reflected by the lens 2.

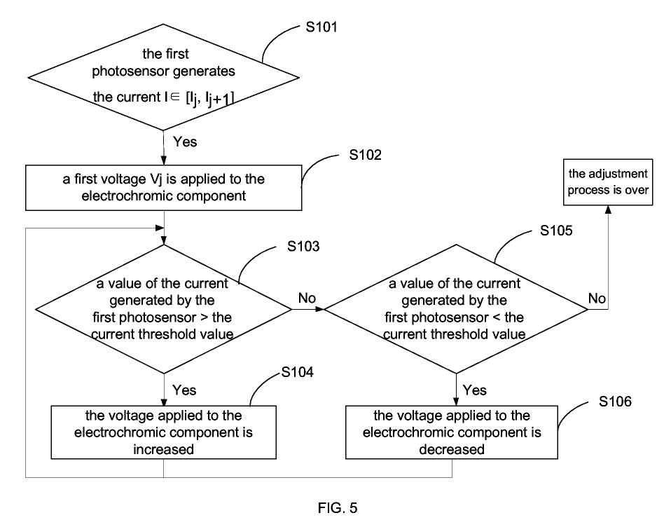

When the first photosensor 3 is disposed at the rear side of the inner lens 22 and is located inside the color changing space, for example, in the implementation (the implementation shown in FIG. 3) where the first photosensor 3 is disposed inside the second region 221, the first photosensor 3 is located at the rear side of the lens 2, i.e., the light intensity measured by the first photosensor 3 is a light intensity after penetrating the lens 2, if the electrochromic component 23 has been applied with a voltage, the light intensity measured by the first photosensor 3 is not an actual intensity of the light from the front side of the anti-glare rearview mirror. In order to make sure the first photosensor 3 still reflect an actual intensity of the light from the front side of the anti-glare rearview mirror and in turn make sure the rearview mirror play a better role in anti-glare, as shown in FIG. 5, the controller is configured to apply a second voltage to the electrochromic component 23 when a value of the current generated by the first photosensor 3 is in a second current value interval; after the electrochromic component 23 is applied with the second voltage, the controller is further configured to perform at least one time of adjustment process: if a value of the present current generated by the first photosensor 3 is greater than a current threshold value, the present voltage applied to the electrochromic component 23 is increased; wherein, the second current value interval is one of a plurality of subintervals into which the current value interval of the first photosensor 3 is divided, for example, the current value interval of the first photosensor 3 may be equally divided into a plurality of subintervals, the second current value interval [Iⱼ, Iⱼ₊₁] is the j-th subinterval of the plurality of equally divided subintervals; the second voltage is a voltage, when the voltage applied to the electrochromic component 23 is zero, making the light from which the second current value interval is generated reach a predetermined light intensity range after passing through the electrochromic component 23, as shown in table 2; the current threshold value is, in a case where the electrochromic component 23 is applied with a certain voltage, a value of the current generated by the first photosensor 3 when the light passing through the electrochromic component reaches a predetermined light intensity range.

After the electrochromic component 23 is applied with a second voltage, it can be accurately determined whether the intensity of the light from the front side of the anti-glare rearview mirror exceeds the determined light intensity range by comparing the value of the current generated by the first photosensor 3 with the current threshold value, thus the light transmission ratio of the electrochromic component 23 may be decreased by increasing the voltage (a step size may be preset previously) applied to the electrochromic component 23. And after the controller performs at least one time of adjustment process until it is over, the intensity of the light reflected into the drivers eyes is not too high, and a glare generated by too strong light is avoided.

It should be noted that: (1) a voltage which is applied to the electrochromic component 23 corresponding to the values at end point of the second current value interval may be measured by the following method: taking the anti-glare rearview mirror with the first photosensor 3 disposed on the rear surface of the inner lens 22 as a test object (as shown in FIG. 3), a value of the voltage applied to the electrochromic component 23 is set to 0V, the lens 2 is irradiated with light of a certain intensity so that a current Iⱼ is generated by the first photosensor 3, and then the light intensity stays the same, and the value of the voltage applied to the electrochromic element 23 is adjusted in order from small to large, when the light reflected by the lens 2 reaches a predetermined light intensity range, a value of the voltage Vⱼ applied to the electrochromic component 23 is the voltage corresponding to Iⱼ, therefore, the second voltage is, in a case where the voltage applied to the electrochromic component is zero and the value of the current generated by the first photosensor 3 under light is Iⱼ, a voltage applied to the electrochromic component 23 when the light reaches a predetermined light intensity range after being reflected by the lens 2.

TABLE 2
Correspondence between an value at an end point
of the second current value interval and a voltage
applied to the electrochromic component

| | voltage which is applied to the |
|---|---|
| | electrochromic component corresponding |
| value at an end point of the | to the value an end point of the |
| second current value interval | second current value interval |
| I₁ | V₁ |
| I₂ | V₂ |
| . . . | . . . |
| Iⱼ | Vⱼ |
| . . . | . . . |
| Iₙ | Vₙ |

The n is the maximum value of j in table 2.

(2) a relation between the above current threshold value and a voltage V_{Dk} applied to the electrochromic component 23 at present may be obtained by a test method. Since every different light intensity from the front side of the anti-glare rearview mirror corresponds to a light transmission ratio of the electrochromic component 23 (a light transmission ratio that can make the light reflected by the lens 2 reach a predetermined light intensity range under a certain light intensity), and a light transmission ratio of the electrochromic component 23 corresponds a value of the voltage applied to the electrochromic component 23, so that in a case of this light intensity and this voltage applied to the electrochromic component 23, the first photosensor 3 may generate a corresponding current. For example, the current threshold value I_{Dk} corresponding to the voltage V_{Dk} applied to the electrochromic component may be measured by the following method, taking the anti-glare rearview mirror with the first photosensor 3 disposed on the rear side surface of the inner lens 22 and located inside the second region 221 as a test object, when the voltage V_{Dk} is applied to the electrochromic component 23, different intensity of light is irradiated to the lens 2 in an order from strong to weak, if the light reflected by the lens 2 reaches the predetermined light intensity range under a certain intensity of light irradiates to the lens 2, then the value of the current I_{Dk} generated by the first photosensor 3 is the current threshold value corresponding to the voltage V_{Dk}. Therefore, the current threshold value I_{Dk} is, in a case where the value of the voltage applied to the electrochromic component 23 is Vₐ, a value the current generated by the first photosensor 3 when the light reflected by the lens 2 reaches a predetermined light intensity range.

TABLE 3
Correspondence between a value of the voltage V_{Dk} applied to the
electrochromic component and a current threshold value I_{Dk}

| | current threshold value |
|---|---|
| | (a value of the current |
| value of the voltage | generated by the first |
| V_{Dk} applied to the | photosensor corresponding |
| electrochromic component | to every different voltage V_{Dk}) |
| V_{D1} | I_{D1} |
| V_{D2} | I_{D2} |
| . . . | . . . |
| V_{Dk} | I_{Dk} |

When the anti-glare rearview mirror is in operation, after a second voltage is applied to the electrochromic component 23, it may be accurately determined whether the intensity of the light from the front side of the anti-glare rearview mirror exceeds the light intensity that generates glare by comparing an actual value of the current generated by the first photosensor 3 with the current threshold value corresponding to the voltage applied at present to the electrochromic component 23 (as shown in table 3).

The second voltage may be a voltage which is applied to the electrochromic component 23 corresponding to a small end point (i.e., a left end point) of the second current value interval. For example, as shown in FIG. 5, when a current I generated by the first photosensor 3 is located in a second current value interval [Iⱼ, Iⱼ₊₁], the second voltage applied to the electrochromic component 23 is the voltage Vⱼ corresponding to the small end point Iⱼ of the second current value interval. Or, the second voltage may also be a voltage which is applied to the electrochromic component 23 corresponding to a big end point (i.e., a right end point) of the second current value interval, for example, when a current I generated by the first photosensor 3 is located in a second current value interval [Iⱼ, Iⱼ₊₁], the second voltage applied to the electrochromic component 23 is the voltage Vⱼ₊₁ corresponding to the big end point Iⱼ₊₁ of the second current value interval. In addition, the second voltage may also be a voltage applied to the electrochromic component 23 corresponding to any value of the second current value interval; the above second voltage can be determined according to an actual situation, and is not limited herein.

The type of the second current value interval is not unique, for example, it may be a closed interval [Iⱼ, Iⱼ₊₁], as shown in FIG. 5; in addition, the second current value interval may also be a left open right closed interval, a left closed right open interval, and is not limited herein.

The values of the voltage which is applied to the electrochromic component 23 corresponding to the end point current values Iⱼ, Iⱼ₊₁ of the second current value interval [Iⱼ, Iⱼ₊₁] may be measured by a test method, the test method is the same as the method of testing the values of the voltage which is applied to the electrochromic component 23 corresponding to the end point values of the first current value interval, which is not described again herein.

In the implementation where the first photosensor 3 is disposed on the rear side surface of the inner lens 22 and inside the second region 221 (the implementation shown in FIG. 3), as shown in FIG. 5, the adjustment process configured to be performed by the controller further includes: if the value of the current I generated by the first photosensor 3 is less than the current threshold value, the voltage applied to the electrochromic component 23 at present is decreased, then the light transmission ratio of the electrochromic component 23 is increased, and an intensity of light reflected into a drivers eyes is not too low, so that the reflected light is always in an optimal intensity range, the display effect of the rearview mirror is ensured.

As shown in FIG. 2 and FIG. 3, the anti-glare rearview mirror provided by some embodiments of the present disclosure further includes a second photosensor 5, the second photosensor 5 is configured to sense a intensity of light from a rear side of the anti-glare rearview mirror. In this way, whether to activate the anti-glare function may be determined according to the relationship between the values of the current generated by the first photosensor 3 and the second photosensor 5 respectively, so that the anti-glare rearview mirror is prevented from mistakenly activating the anti-glare function to cause unnecessary power consumption when the anti-glare rearview mirror is in the daytime mode and the intensities of light from the front and rear sides of the anti-glare rearview mirror are both strong and the same.

In a case where the anti-glare rearview mirror provided by some embodiments of the present disclosure further includes the second photosensor 5, the controller is configured to, when a value of the current generated by the first photosensor 3 is greater than a value of a current generated by the second photosensor 5, adjust a voltage applied to the electrochromic component 23 according to the value of the current generated by the first photosensor 3, and then a light transmission ratio of the electrochromic component 23 is changed; when a value of the current generated by the first photosensor 3 is less than a value of a current generated by the second photosensor 5, the anti-glare function is not activated, and the light transmission ratio of the electrochromic component 23 maintains a maximum light transmission state.

In the anti-glare rearview mirror provided by some embodiments of the present disclosure, the first photosensor 3 may be a photodiode, or may also be a photoresistor, etc, which is not limited herein; the anti-glare rearview mirror provided by some embodiments of the present disclosure may be a rearview mirror disposed on a vehicle.

Some embodiments of the present disclosure provide a use method of the anti-glare rearview mirror, including the following steps: the first photosensor 3 disposed at a rear side of the outer lens 21 receives light irradiated from a front side of the anti-glare rearview mirror and generates a corresponding current; a voltage applied to the electrochromic component 23 is adjusted according to the value of the current generated by the first photosensor 3.

An executive body of the above step of adjusting the voltage applied to the electrochromic component may be a controller.

Therefore, by adjusting the voltage applied to the electrochromic component 23, a light transmission ratio of the electrochromic component 23 may be changed, so that strong light is avoided to reflected into a drivers eyes, and driving safety is improved.

The technical problems to be solved by and the beneficial effects of the use method of the anti-glare rearview mirror provided by some embodiments of the present disclosure are the same as those of the anti-glare rearview mirror, and are not described herein again.

For different rearview mirror structures, use methods of the anti-glare rearview mirrors are different. For example, in the implementation where the first photosensor 3 is disposed at the rear side of the outer lens 21 and located outside the color changing space, the step “a voltage applied to the electrochromic component 23 is adjusted according to the value of the current generated by the first photosensor 3” includes: a first voltage is applied to the electrochromic component 23 when a value of the current generated by the first photosensor 3 is in a first current value interval.

For example, as shown in FIG. 4, in this implementation, this use method may includes:

S11, that whether a value of the current I generated by the first photosensor 3 is located in the first current value interval [Iᵢ, Iᵢ₊ⱼ] is determined;

if the value of the current I generated by the first photosensor 3 is located in the first current value interval [Iᵢ, Iᵢ₊₁], S12 is executed: a first voltage Vᵢ is applied to the electrochromic component 23 to change a light transmission ratio of the electrochromic component 23.

In the implementation where the first photosensor 3 is disposed at the rear side of the inner lens 22 and located inside the color changing space, the step “a voltage applied to the electrochromic component 23 is adjusted according to the value of the current generated by the first photosensor 3” includes: a second voltage is applied to the electrochromic component 23 when a value of the current generated by the first photosensor 3 is in a second current value interval; after the electrochromic component is applied with the second voltage, if a value of the present current generated by the first photosensor 3 is greater than a current threshold value, a present voltage applied to the electrochromic component 23 is increased.

In the implementation where the first photosensor 3 is disposed at the rear side of the inner lens 22 and located inside the color changing space, in order to ensure a reflected light of the rearview mirror is in an optimal intensity range, after the second voltage is applied to the electrochromic component 23 according to the value of the current generated by the photosensor, the step further includes: when a value of the present current generated by the first photosensor 3 is less than a current threshold value, a voltage applied to the electrochromic component 23 is decreased.

For example, as shown in FIG. 5, in this implementation, this use method may includes:

S101, that whether a value of the current I generated by the first photosensor 3 is located in the second current value interval [Iⱼ, Iⱼ₊₁] is determined; if the value of the current I generated by the first photosensor 3 is located in the second current value interval [Iⱼ, Iⱼ₊₁], S102 is executed: a second voltage Vⱼ is applied to the electrochromic component 23; after the electrochromic component 23 is applied with the second voltage Vⱼ, S103 is executed: that whether a value of the current generated by the first photosensor 3 is greater than the current threshold value is determined; if the value of the current generated by the first photosensor 3 is greater than the current threshold value, S104 is executed: the voltage applied to the electrochromic component 23 is increased;

if the value of the current generated by the first photosensor 3 is less than or equal to the current threshold value, S105 is executed: that whether the value of the current generated by the first photosensor 3 is less than the current threshold value is determined; if the value of the current generated by the first photosensor 3 is less than the current threshold value, S106 is executed: the voltage applied to the electrochromic component 23 is decreased; if the value of the current generated by the first photosensor 3 is equal to the current threshold value, the adjustment process is over.

It should be noted that: the order for execution of S103 and S105 is not limited, for example, S103 may be executed firstly, and if the result of S103 is no, then S105 is executed; or, S105 may be executed firstly, and if the result of S105 is no, then S103 is executed.

In a case where the anti-glare rearview mirror further includes a second photosensor 5, when a value of the current generated by the first photosensor 3 is greater than a value of a current generated by the second photosensor 5, a voltage applied to the electrochromic component 23 is adjusted according to the value of the current generated by the first photosensor 3 to change a light transmission ratio of the electrochromic component 23; when a value of the current generated by the first photosensor 3 is less than or equal to a value of a current generated by the second photosensor 5, the anti-glare function is not activated, and the light transmission ratio of the electrochromic component 23 maintains in a maximum light transmission state.

The foregoing descriptions are merely some specific implementation manners of the present disclosure, but the protection scope of the present disclosure is not limited thereto. Any person skilled in the art could readily conceive of changes or replacements within the technical scope of the present disclosure, which shall all be included in the protection scope of the present disclosure. Therefore, the protection scope of the present disclosure shall be subject to the protection scope of the claims.

What is claimed is:

1. An anti-glare rearview mirror, comprising:
a lens, the lens comprises an outer lens and an inner lens, the inner lens is located at a rear side of the outer lens;
a first photosensor, the first photosensor is disposed on the lens and is located at a rear side of the outer lens, and the first photosensor is configured to receive light irradiated from a front side of the anti-glare rearview mirror and generate a corresponding current; and
an electrochromic component, the electrochromic component is located between the outer lens and the inner lens, and the electrochromic component is configured to be applied with a corresponding voltage according to the current generated by the first photosensor, and then change a light transmission ratio of the electrochromic component.

2. The anti-glare rearview mirror according to claim 1, wherein, the lens comprises a color changing space, the color changing space is a space formed by an orthographic projection of the electrochromic component projected on the lens along a thickness direction of the lens, and the first photosensor is disposed outside the color changing space.

3. The anti-glare rearview mirror according to claim 2, wherein, the outer lens comprises a first region, the first region is a region formed by an orthographic projection of the electrochromic component projected on the outer lens along a thickness direction of the outer lens, and the first photosensor is disposed on a rear side surface of the outer lens and is located outside the first region.

4. The anti-glare rearview mirror according to claim 2, wherein, the inner lens is a transflective lens.

5. The anti-glare rearview mirror according to claim 2, further comprising a controller,
the controller is configured to apply a first voltage to the electrochromic component when a value of the current generated by the first photosensor is in a first current value interval;
wherein, the first current value interval is one of a plurality of subintervals into which the current value interval of the first photosensor is divided; the first voltage is a voltage capable of making the light from which the first current value interval is generated reach a predetermined light intensity range after the light passing through the electrochromic component;
the predetermined light intensity range is an anti-glare light intensity range.

6. The anti-glare rearview mirror according to claim 5, wherein, the first voltage is a voltage which is applied to the electrochromic component corresponds to a small end point of the first current value interval.

7. The anti-glare rearview mirror according to claim 1, wherein, the lens comprises a color changing space, the color changing space is a space formed by an orthographic projection of the electrochromic component projected on the lens along a thickness direction of the lens, and the first photosensor is disposed inside the color changing space.

8. The anti-glare rearview mirror according to claim 7, wherein, the inner lens is a transflective lens, the inner lens comprises a second region, the second region is a region formed by an orthographic projection of the electrochromic component projected on the inner lens along a thickness direction of the inner lens, and the first photosensor is disposed on a rear side surface of the inner lens and is located inside the second region.

9. The anti-glare rearview mirror according to claim 7, further comprising a controller,
the controller is configured to apply a second voltage to the electrochromic component when a value of the current generated by the first photosensor is in a second current value interval;
wherein, the second current value interval is one of a plurality of subintervals into which the current value interval of the first photosensor is divided; the second voltage is a voltage, when the voltage applied to the electrochromic component is zero, capable of making the light from which the second current value interval is generated reach a predetermined light intensity range after the light passing through the electrochromic component;
after the electrochromic component is applied with the second voltage, the controller is further configured to perform at least one time of adjustment process: if a value of the present current generated by the first photosensor is not equal to a current threshold value, the present voltage applied to the electrochromic component is adjusted;
the current threshold value is, in a case where the electrochromic component is applied with a certain voltage, a value of the current generated by the first photosensor when the light passing through the electrochromic component reaches a predetermined light intensity range;
the predetermined light intensity range is an anti-glare light intensity range.

10. The anti-glare rearview mirror according to claim 9, wherein, the second voltage is a voltage which is applied to the electrochromic component corresponds to a small end point of the second current value interval.

11. The anti-glare rearview mirror according to claim 9, wherein, “if a value of the present current generated by the first photosensor is not equal to a current threshold value, the present voltage applied to the electrochromic component is adjusted” comprises:
if the value of the present current generated by the first photosensor is greater than the current threshold value, the present voltage applied to the electrochromic component is increased; or,
if the value of the present current generated by the first photosensor is less than the current threshold value, the present voltage applied to the electrochromic component is decreased.

12. The anti-glare rearview mirror according to claim 1, further comprising a second photosensor, the second photosensor is configured to sense a light intensity at a rear side of the anti-glare rearview mirror.

13. The anti-glare rearview mirror according to claim 12, further comprising a controller,
the controller is configured to, when a value of the current generated by the first photosensor is greater than a value of a current generated by the second photosensor, a voltage applied to the electrochromic component is adjusted according to the value of the current generated by the first photosensor.

14. The anti-glare rearview mirror according to claim 1, further comprising a display device, the display device is located at a rear side of the lens.

15. A use method of the anti-glare rearview mirror according to claim 1, comprising:
receiving, by the first photosensor disposed at a rear side of the outer lens, the light irradiated from a front side of the anti-glare rearview mirror and generating a corresponding current;
adjusting a voltage applied to the electrochromic component according to a value of the current generated by the first photosensor, so that a light transmission ratio of the electrochromic component is changed.

16. The use method according to claim 15, wherein, the lens comprises a color changing space, the color changing space is a space formed by an orthographic projection of the electrochromic component projected on the lens along a thickness direction of the lens, and the first photosensor is located outside the color changing space;
“adjusting a voltage applied to the electrochromic component according to a value of the current generated by the first photosensor” comprises:
a first voltage is applied to the electrochromic component when a value of the current generated by the first photosensor is in a first current value interval;
wherein, the first current value interval is one of a plurality of subintervals into which the current value interval of the first photosensor is divided; the first voltage is a voltage capable of making the light from which the first current value interval is generated reach a predetermined light intensity range after the light passing through the electrochromic component;
the predetermined light intensity range is an anti-glare light intensity range.

17. The use method according to claim 15, wherein,
the lens comprises a color changing space, the color changing space is a space formed by an orthographic projection of the electrochromic component projected on the lens along a thickness direction of the lens, and the first photosensor is located inside the color changing space;
“adjusting a voltage applied to the electrochromic component according to a value of the current generated by the first photosensor” comprises:
a second voltage is applied to the electrochromic component when a value of the current generated by the first photosensor is in a second current value interval;
after the electrochromic component is applied with the second voltage, if a value of the present current generated by the first photosensor is not equal to a current threshold value, a present voltage applied to the electrochromic component is adjusted;
wherein, the second current value interval is one of a plurality of subintervals into which the current value interval of the first photosensor is divided; the second voltage is a voltage, when the voltage applied to the electrochromic component is zero, capable of making the light from which the second current value interval is generated reach a predetermined light intensity range after the light passing through the electrochromic component;
the current threshold value is, in a case where the electrochromic component is applied with a certain voltage, a value of the current generated by the first photosensor when the light passing through the electrochromic component reaches a predetermined light intensity range.

18. The use method according to claim 17, wherein, “if a value of the present current generated by the first photosensor is not equal to a current threshold value, the present voltage applied to the electrochromic component is adjusted” comprises:
if the value of the present current generated by the first photosensor is greater than the current threshold value, the present voltage applied to the electrochromic component is increased; or,
if the value of the present current generated by the first photosensor is less than the current threshold value, the present voltage applied to the electrochromic component is decreased.

19. The use method according to claim 15, wherein, in a case where the anti-glare rearview mirror further comprises a second photosensor,
when a value of the current generated by the first photosensor is greater than a value of a current generated by the second photosensor, a voltage applied to the electrochromic component is adjusted according to the value of the current generated by the first photosensor.
